(19) United States
(12) Patent Application Publication
(10) Pub. No.: US 2012/0095852 A1
(43) Pub. Date: Apr. 19, 2012

(54) METHOD AND SYSTEM FOR ELECTRONIC WALLET ACCESS

(76) Inventors: John Bauer, Downingtown, PA (US); Glenn Curtiss McMillen, Downingtown, PA (US); Eric Crozier, Hockessin, DE (US); Christine Ann Schuetz, Chadds Ford, PA (US); Garry Lloyd, Pitsford (GB)

(21) Appl. No.: 12/905,419

(22) Filed: Oct. 15, 2010

(51) Int. Cl. G06Q 20/00

(52) U.S. Cl. 705/16; 705/41

(57) ABSTRACT

A mobile payment method, system and graphical user interface are described that facilitate efficient and secured payment transactions from an electronic wallet on a user portable electronic device with a merchant point of sale terminal over a contactless communications link. In one aspect, the electronic wallet includes a flag indicating whether input of the passcode is required to access the electronic wallet, which flag can be set by a remote device. In another aspect, a shortcut is provided to directly execute the payment features of the electronic wallet application software.

### FIELD OF THE INVENTION

This invention relates to a mobile payment account system, and more particularly to an improved mobile payment application on a mobile device to enable more efficient and secured contactless payment at an electronic point of sale.

### BACKGROUND OF THE INVENTION

Mobile payment account systems are generally known, in which portable electronic devices are configured to provide payment from an electronic wallet. Typically, these portable electronic devices are configured to enable a contactless communication with a merchant Point Of Sale (POS) terminal to carry out a payment transaction, for example using near field communication (NFC) technology. As described in the Applicant's co-pending application U.S. Ser. No. 12/891,866, incorporated herein by reference in its entirety, activated mobile payment account data may be stored in the secure memory of the portable electronic device which can then be used to carry out transactions with the merchant electronic POS terminal via a NFC link.

However, conventional mobile payment systems typically involve a complicated process in order for a user to effect a secured payment transaction from an electronic wallet. For example, U.S. Pat. No. 7,707,113 to Sprint Communications Company L.P. discusses a method of a portable electronic device providing payment from an electronic wallet with different levels of security. In a first level of security, the method prompts for input of a personal identification number (PIN) after the wallet has been opened and providing payment from the wallet after receiving the PIN. However, in another level of security, no PIN is required thus enabling efficient but unsecured payment transactions to be made from the electronic wallet.

Additionally, when customers use such a payment product to conduct low dollar transactions over contactless interfaces, a signature may not be required at the point of sale, nor a challenge for a numeric passcode (PIN) or a password. In the United States for example, customers are able to wave their payment device and authorize the payment transaction without further interaction. For any theft of payment devices, the liability for these low dollar swipe transactions is placed upon the issuing bank, not the customer and not the merchant.

For payment accounts residing on mobile devices such as contactless payment capable mobile phones, the theft of a phone now becomes immediately available for low dollar purchases without consumer verification prior to a purchase. The perpetrator can make as many low dollar transactions without being challenged for authentication and access the payment account. All of these low dollar transactions will be the responsibility of the issuing bank under current payment association dispute rules. Customers may elect to always require a numeric passcode challenge for a purchase transaction regardless of the value, but this is not required.

What is desired is a more efficient mobile payment system and method which facilitates expedient and secured payment transactions from an electronic wallet, and improved prevention of fraudulent use of the electronic wallet.

### SUMMARY OF THE INVENTION

In one aspect of the present invention, a method is provided of facilitating secured payment from an electronic wallet on a portable device, comprising storing, on the portable device, an electronic wallet comprising data for completing a payment transaction, wherein said data includes a passcode for enabling access to the electronic wallet and a flag indicating whether input of the passcode is required to access the electronic wallet; receiving a command from a device remote from the portable device to set the flag to indicate that input of the passcode is required to access the electronic wallet; and responsive to a request to conduct a payment transaction from the electronic wallet, prompting for input of a passcode if the flag indicates that input of the passcode is required, verifying the input passcode, and providing payment information to authorize the payment transaction.

In another aspect, the present invention provides a method is provided of facilitating payment from an electronic wallet on a portable device, comprising storing, on the portable device, wallet application software for accessing the electronic wallet, including executable code for facilitating access to data defining one or more mobile payment accounts in the electronic wallet and executable code for facilitating activation of a secure payment from a mobile payment account; storing, on the portable device, a further payment application software associated with the executable code in the wallet application software for facilitating activation; and receiving a user input selection of the second application software and in response, directly executing the associated executable code in the first application software to facilitate activation of a secure payment from the mobile payment account.

In yet another aspect, the present invention provides a graphical user interface for facilitating payment from an electronic wallet on a portable device, comprising a first icon associated with wallet application software for accessing the electronic wallet, including executable code for facilitating access to data defining one or more mobile payment accounts in the electronic wallet and for facilitating activation of a secure payment from a mobile payment account, a second icon associated with executable code for facilitating direct activation of a secure payment from a mobile payment account, and receiving user selection of the second icon and directly executing the application software for facilitating activation of a secure payment from a mobile payment account.

In yet a further aspect, there is provided a portable device and computer program arranged to carry out the above method when executed by a portable device.

### BRIEF DESCRIPTION OF THE DRAWINGS

There now follows, by way of example only, a detailed description of embodiments of the present invention, with references to the figures identified below.

FIG. 1 is a block diagram showing the main components of a mobile payment system according to an embodiment of the invention.

FIG. 2a is a block diagram showing the main hardware and/or software elements of a mobile device shown in FIG. 1 according to an embodiment.

FIG. 2b is a block diagram showing the main functional elements of the mobile device shown in FIG. 2a according to embodiments of the invention.

FIG. 3 is a flow diagram illustrating the main processing steps performed by the mobile device of FIGS. 1 and 2 in a mobile payment process according to an embodiment.

FIG. 4, which comprises FIGS. 4a to 4c, is a flow diagram illustrating the main processing steps performed by the main components of the mobile payment system of FIG. 1 in the step of processing user inputs to activate a payment feature on the mobile device as illustrated in FIG. 3.

FIG. 5, which comprises FIGS. 5a to 5f, illustrates a sequence of screens displayed by the mobile device to the user during a mobile payment process according to embodiments of the present invention.

FIG. 6, which comprises FIGS. 6a to 6d, illustrates a sequence of screens displayed by the mobile device to the user during a process for setting a default mobile payment account on the mobile device.

### DETAILED DESCRIPTION OF EMBODIMENTS OF THE INVENTION

### Overview

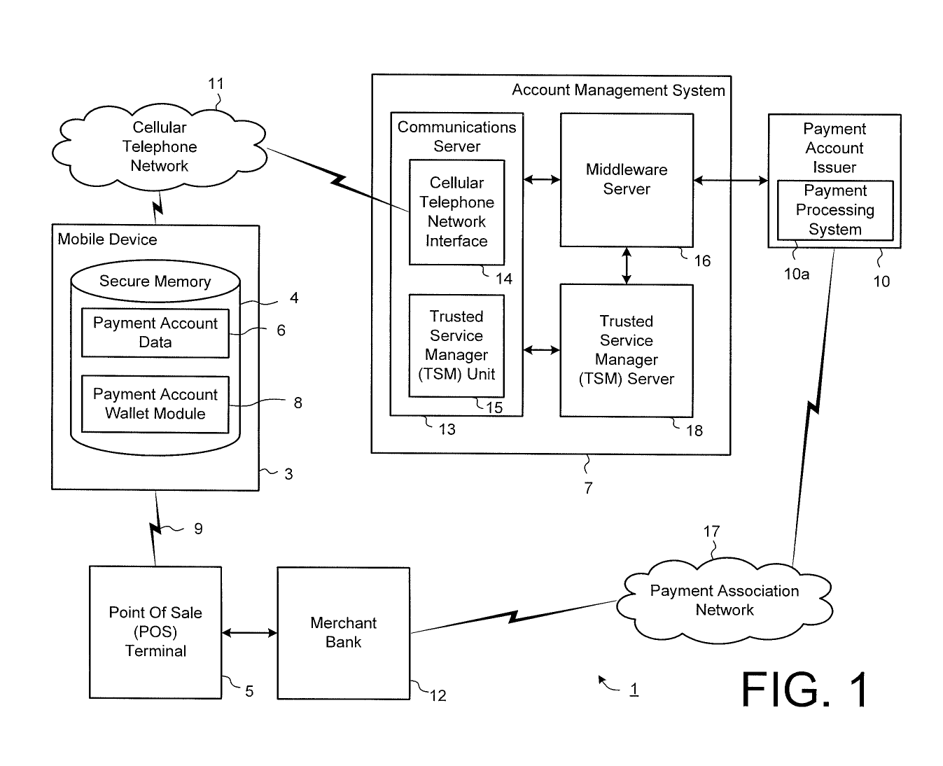

A specific embodiment of the invention will now be described for a process for conducting a payment transaction using a mobile device at a merchant's electronic point of sale terminal. Referring to FIG. 1, a mobile payment system 1 according to an embodiment comprises a mobile device 3, a merchant's electronic Point Of Sale (POS) terminal 5 as commonly known in the field, and a account management system 7 associated with a payment account issuer 10, which communicate electronically with one another. The account management system 7 may provide for mobile payment account creation and activation, transaction authorization, and other related functionality, as described in the Applicant's above-referenced co-pending application U.S. Ser. No. 12/891,866. As will be described below, the account management system 7 may include a communications server 13 and a Trusted Service Manager (TSM) server 18 for facilitating communication between the middleware server 16 and the mobile device 3. The payment account issuer 10 may include a payment processing (authorization and fraud monitoring) system 10a for authorizing and effecting payment transactions from payment accounts associated with the payment account issuer 10, for example in response to payment transaction instructions received via a payment association network 17. In this embodiment, the mobile device 3 and the electronic POS terminal 5 communicate with one another via a contactless communication link 9. As those skilled in the art will appreciate, this contactless communication link 9 may be for example a near field communication (NFC) link, an infra-red link, an ultra-sonic link, an optical link, a radio frequency (eg. RFID) link, a wireless link such as Bluetooth or Wi-Fi based on the IEEE 802.11 standards, or any other communication link that does not require direct physical contact. The mobile device 3 may also communicate with the account management system 7 via a cellular telephone network 11.

As shown in FIG. 1, the mobile device 3 in this embodiment includes a secure memory 4 storing payment account data 6 for one or more mobile payment accounts that have been set up on the mobile device 3. The secure memory 4 may for example be a Universal Integrated Circuit Card (UICC) secure element, any other secure memory configurations such as embedded secure element chips, or as part of an peripheral accessory device to the mobile device such as a micro Secure Digital card—otherwise known as a micro SD card, as are known in the art. As those skilled in the art will appreciate, other forms of mobile handset software and/or hardware may be implemented to provide built-in secure electronic wallet functionality for accessing the secure memory 4, including encryption and decryption of the payment account data 6 as necessary. For example, the mobile device 3 may be configured with built-in functionality providing access to secure memory on the Subscriber Identity Module (SIM) card in the mobile device 3. In the present embodiment, payment account data 6 for a mobile payment account that is securely stored in the mobile device 3 may include data defining an amount of pre-paid funds that have been transferred from the user's payment account issuer 10 to that mobile payment account. Alternatively or additionally, the payment account data 6 may include data identifying a user's account at a payment account issuer 10 from which funds can be transferred to the merchant bank to complete a transaction, via a payment association network 17 for example. In this way, the electronic wallet includes a payment account that may be linked to multiple funding sources, such as a pre-paid account, deposit account and/or credit account. As an alternative, the electronic wallet may include a plurality of mobile payment accounts, each linked to a respective funding source.

The mobile device 3 also includes a payment account wallet application module 8 storing processing instructions used to control the operation of the mobile device 3, for example to facilitate creation and management of one or more mobile payment accounts on the mobile device 3 and to handle the process of conducting a transaction with a merchant via the electronic POS terminal 5 using a mobile payment account on the mobile device 3, to effectively transfer funds from the mobile payment account on the mobile device 3 or an associated payment account issuer 10 to the merchant. As those skilled in the art will appreciate, the payment account wallet application module 8 may be provided as one or more software components of an operating system running on the mobile device 3 or as one or more separate software applications installed on the mobile device 3. Such software applications may be configured to run as background applications on the mobile device 3 that monitor for and activate upon receipt of appropriate messages or events, or may be launched by the user, so as to carry out the above operations. Alternatively, the payment account wallet application module 8 may be stored in the secure memory 4, and may for example be loaded into a virtual machine of the mobile device 3 to provide the functionality of the present embodiment.

A secure mobile payment account provisioning and activation process may be carried out between the mobile device 3 and the account management system 7, as described in the Applicant's above referenced co-pending application U.S. Ser. No. 12/891,866. The activated mobile payment account data stored in the secure memory 4 of the mobile device 3 can then be used to carry out transactions with a merchant electronic POS terminal 5 via the contactless communication link 9, whereby a requested amount of funds can be transferred from the mobile payment account stored in the mobile device 3 to the merchant's bank 12. Techniques and protocols for implementing the authorization and transfer of funds between the merchant POS terminal 5, the merchant bank 12, and the payment account issuer 10, for example via the payment association network 17, are commonly known and will be apparent to those skilled in the art.

Account Management System

The account management system 7 in the mobile payment system 1 will now be described in more detail with reference to FIG. 1, which shows the elements of the account management system 7 used in embodiments of the present invention. As shown, the account management system 7 may include a communications server 13, a middleware server 16, and a Trusted Service Manager (TSM) server 18, which communicate electronically with one another. In this embodiment, the servers communicate with one another via secure network links, for example over a private Local Area Network (LAN), a VPN connection, or other dedicated secure connection. As those skilled in the art will appreciate, although the components of the account management system 7 in this embodiment are provided as separate servers, one or more of the servers could be provided as software and/or hardware modules in the same server.

As shown in FIG. 1, data may be communicated between the mobile device 3 and the middleware server 16 over the cellular telephone network 11 via a cellular telephone network interface 14 of the communications server 13. The TSM server 18 may perform logical data preparation of the data to be communicated to the mobile device, for example by forming appropriate commands to be written to the secure memory 4 of the mobile device 3. As those skilled in the art will appreciate, the precise form of the data may depend on the particular implementation of the secure memory 4 of the mobile device 3 and/or the payment association scheme program for facilitating payment. The TSM server 18 may also perform encryption of the data, for example of the sensitive payment account information in the mobile payment account data 6 such as payment keys. The TSM server 18 may then pass the encrypted data to the mobile device 3 via the communications server 13 and the cellular telephone network 11.

The communications server 13 may also include a separate TSM unit 15 for securely routing the data to the mobile device 3, as will be known to the skilled person. In the above example, the TSM unit 15 in the communications server 13 would not access any of the sensitive portions of the encrypted data that is routed to the mobile device 3 via the cellular telephone network interface 14.

Mobile Device

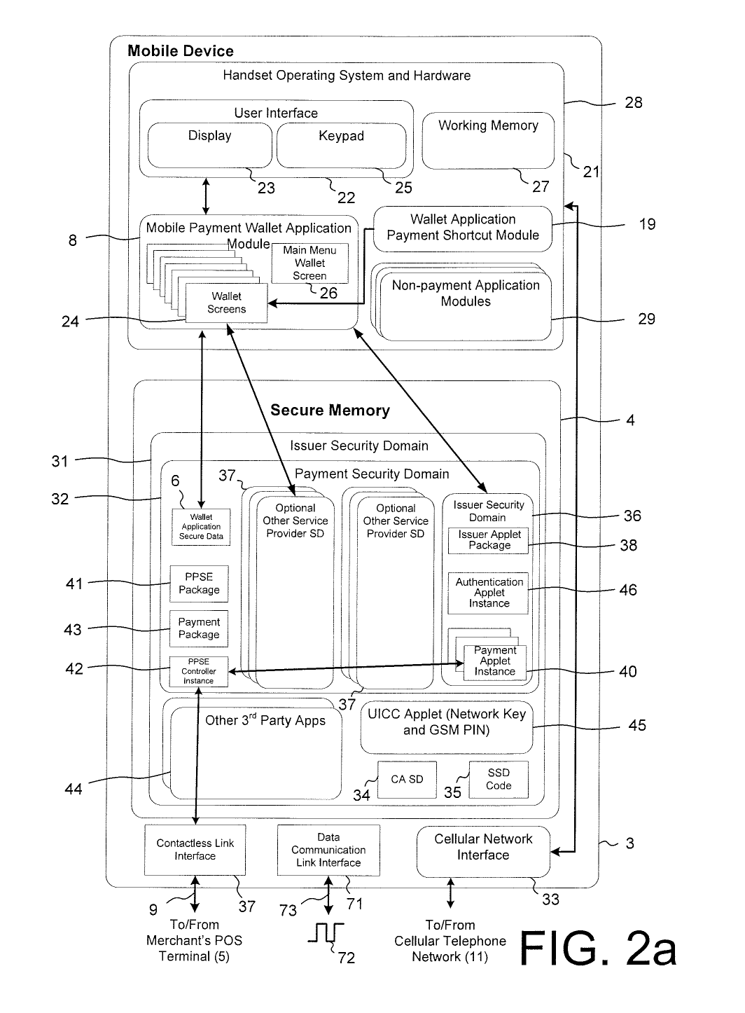

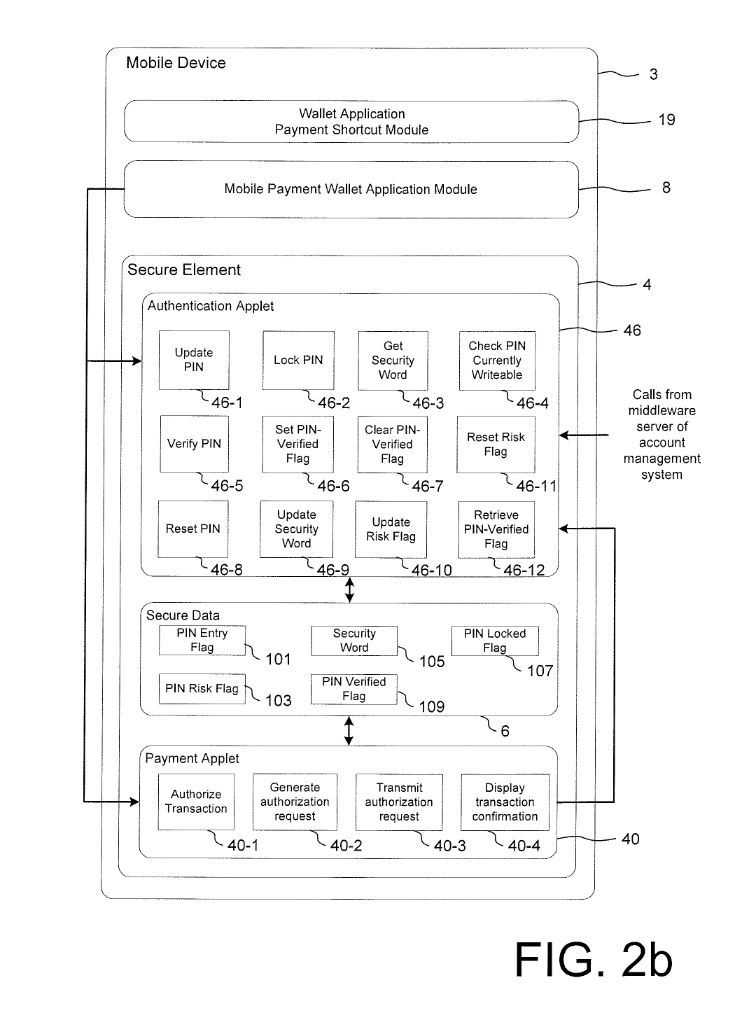

FIG. 2, which comprises FIGS. 2a and 2b, shows the elements of the mobile device 3 according to an embodiment of the present invention. In this embodiment, the mobile device 3 is a mobile handset and as shown in FIG. 2a, the mobile handset operating system and hardware includes a user interface 22 arranged to process inputs from a keypad 23 and to control output on a display 25. As those skilled in the art will appreciate, the keypad 23 and display 25 may be provided as separate hardware entities of the mobile device 3 or may alternatively be provided as an integrated entity, for example as a touch sensitive display screen user interface element as is known in the art. The mobile device 3 may also include components included in commonly known mobile handsets, such as a microphone, an earpiece speaker, camera and controller, GPS sensors etc, which are not shown for clarity. A working memory 27 is provided for use by the handset operating system and hardware units 21.

Software and data may be transferred via the cellular network interface 33 or via a different data communication link interface 71 for example in the form of signals 72, which may be electronic, electromagnetic, optical, or other signals capable of being received by the data communication link interface 71 via a communication path 73 that carries the signals 72 and may be implemented using wire or cable, fiber optics, a physical phone line, a wireless link, a radio frequency link, or any other suitable communication channel. For instance, communication path 73 may be implemented using a combination of channels. As those skilled in the art will appreciate, the communication path 73 may be linked or merged with the communication path from the cellular network interface 33 to the cellular telephone network 11.

As mentioned above, the mobile device 3 includes a secure memory 4. The mobile device 3 is operable to receive the payment account data 6 and activation request messages from and send validation messages to the account management system 7 via a cellular telephone network interface 33 and the cellular telephone network 11, and to store the received payment account data 6 in the secure memory 4. The mobile device 3 is also operable to receive transaction authorization request messages from and send authorization messages to the merchant's POS terminal 5 via a contactless communications link interface 37 and the contactless communications link 9. As those skilled in the art will appreciate, communication between a POS terminal 5 and the mobile device 3 may involve transmission of data in a single direction from the mobile device 3 to the POS terminal 5, depending on an implemented protocol (such as the well known protocol used by the Discover Zip cashless payment system).

The mobile device 3 also includes a payment account wallet application module 8 as mentioned above, which stores processing instructions used to control the operation of the mobile device 3 to perform the various mobile payment account processes, as will be described below. As schematically illustrated in FIG. 2a, the payment account application wallet module 8 may include an account creation sub-module and an account activation sub-module which store processing instructions to create a request for a new mobile payment account if desired and to carry out a secured account validation and activation process, in response to user input from the keypad 23, as described in the above-referenced Applicant's co-pending application Ser. No. 12/891,866. The payment account module 8 also includes a transaction authorization sub-module which stores processing instructions used to control the operation of the controller 21 to carry out and authorize a transaction in response to user input from the user interface 22. The mobile payment wallet application module 8 may be configured to store a plurality of wallet screens 24 and an account access screen 26 which may be output on display 23 of the user interface 22 to facilitate user interaction with the sub-modules of the mobile payment wallet application module 8. One wallet screen is a main menu wallet screen 26 which may be displayed initially by the wallet application module 8 in response to a user command to launch the wallet application. The mobile device 3 may also store one or more non-payment application modules 29 including processing instructions used to control the operation of the mobile device 3 to perform other non-payment related processes.

In this embodiment, the mobile device 3 further includes a payment shortcut module 19 that provides a shortcut to the payment feature within the mobile payment wallet application module 8. The shortcut may be implemented as processing instructions that link to the processing instructions of the transaction authorization sub-module. Alternatively, the payment shortcut module 19 may comprise separate processing instructions used to control the operation of the controller 21 to carry out and authorize a transaction in response to user input from the user interface 22. Provision of the payment shortcut module 19 advantageously enables an improved user interface for the transaction payment process that expedites the purchase process at a POS terminal 5 as the user avoids having to navigate through multiple wallet screens of the mobile payment wallet application module 8 to authorize a payment transaction from the electronic wallet.

In an embodiment, the mobile payment wallet application module 8 may facilitate user navigation from any one of the wallet screens 24 to the main menu wallet screen 26. As those skilled in the art will appreciate, such navigation to the main menu wallet screen 26 may be direct or via one or more intermediary wallet screens 24. In this way, even though a user may have accessed the payment features of the wallet application module directly using the wallet application payment shortcut module 19 of the present invention, the user may be able to navigate to any other wallet screen 24 of the mobile payment wallet application module 8.

Also schematically illustrated in the exemplary embodiment of FIG. 2a are a plurality of security domains which may be implemented in the secure memory 4 of the mobile device 3. The security domains serve to segment the management and accessibility of various parties' functionality and sensitive data as will be apparent to those skilled in the art. As shown in FIG. 2a, an issuer security domain 31 may include a payment security domain 32, a Controlling Authority (CA) security domain 34, and a Supplementary Security Domain (SSD) code 35. The payment security domain includes the wallet application secure data 6, along with an issuer security domain 36 and one or more optional other service provider security domains 37. The issuer security domain 36 may include an issuer applet package 38, an authentication applet instance 46, and one or more payment applet instances 40 which enable the transaction processing functionality using an activated mobile payment account. The payment security domain 32 may also include a Proximity Payment System Environment (PPSE) package 41, a PPSE controller instance 42 for facilitating the transaction processing functionality between the payment applet instances 40 and the contactless link interface 37, and a payment package 43.

The mobile device 3 may also include one or more other third party application modules 44 stored in the secure memory 4, for example an application module related to third party loyalty scheme. The secure memory 4 may also stores a UICC applet 45 which is an application to manage and hold the mobile network operator's functionality and secure information, such as a network key and GSM PIN.

FIG. 2b is a block diagram showing the main functional elements of the mobile device when configured to execute processing instructions of the payment applet 40 and the authentication applet 46, according to an embodiment of the invention. As will be discussed in greater detail below, the mobile payment wallet application module 8 may call the payment applet instance 40 to conduct a payment transaction process for example when a user waves the mobile device 3 past the contactless communication interface of the POS terminal 5. As shown in FIG. 2b, in this embodiment, the payment applet 40 may provide functional elements for authorizing a transaction 40-1, generating an authorization request 40-2, transmitting an authorization request 40-3 and displaying confirmation of a completed payment transaction 40-4, for example. The payment applet 40 may call the authentication applet instance 46 to process, authorize and allow a payment transaction to proceed. The authentication applet 46 tells the payment application if the PIN has been set and if it will allow the transaction to proceed based upon various PIN entry flags. As shown in FIG. 2b, the authentication applet 46 may also provide functional elements for updating the PIN 46-1, locking the PIN 46-2, obtaining a user defined security word 46-3 from the secure data 6, checking if the PIN is currently writeable 46-4, verifying the PIN 46-5, setting a PIN-verified flag 46-6, clearing a PIN-verified flag 46-7, resetting the PIN 46-8, updating the security word 46-9, updating the Risk flag 46-10, resetting the Risk flag 46-11 and retrieving the PIN-verified flag 46-12. Functional elements 46-1 to 46-7 and 46-11 are typically called by the mobile payment wallet application module 8, as will be described below. Functional elements 46-8 to 46-10 may be called by the account management system 7, for example from the middleware server 16 via the TSM server 18 in the form of APDU commands to execute in the secure element for remotely setting the PIN risk flag 103, as will be described below. Functional elements 46-12, as well as 46-7, are typically called by the payment applet 40.

The authentication applet 46 maintains a PIN entry flag 101 for the state of PIN entry, a PIN risk flag 103, a security word 105, a PIN locked state 107 (from an issuer perspective) and a PIN-verified flag 109, which are stored securely as wallet application secure data 6 in the secure memory 4 of the mobile device 3. In this embodiment, the PIN risk flag 103 is provided as an indication that an incorrect PIN was previously entered on the handset and therefore advantageously facilitates prevention of fraud from the issuer perspective, because the customer can be forced to enter a PIN effectively by setting the PIN risk flag 103. The PIN risk flag 103 further allows for flexibility in not forcing a PIN for low dollar transactions while keeping control over the use of the mobile payment account. Transactions may be allowed to continue uninterrupted unless certain conditions arise requiring PIN verification, which may include for example:

An authorization message includes indication that incorrect PIN was previously entered and no correct PIN was provided for this transaction (as those skilled in the art will appreciate, this is possible for example with option 2 for dCVV); in such an instance, the middleware server 16 can choose to decline the payment transaction.

Built-in logic to prompt for PIN entry if PIN was previously entered incorrectly or a configurable number of times without a PIN.

Built in logic to detect remote set PIN entry required for next transaction.

For example, when the PIN risk flag 103 is set to true, the authentication applet 46 may cause the payment applet 40 to raise itself asking for PIN entry via a NFC push request. This condition would send an error to the payment applet 40 to not allow a transaction at this time. Upon successful PIN entry, the PIN risk flag may be reset since the customer has successfully entered the PIN and thereby allowing the transaction to be made by the next wave and invocation of the payment applet 40. In effect, the PIN entry flag would be communicated from the authentication applet 46 to the payment applet 40 and through a payment authorization request to a merchant payment transaction authorization system via the electronic POS terminal 5, as is commonly known. The merchant's authorization system would then send the PIN entry information to for example a fraud/risk assessment unit (not shown) of the middleware server 16 to reset the PIN risk flag 103, as will be described in more detail below.

As those skilled in the art will appreciate, as an alternative, the processing instructions and functionality of the payment applet 40 and the authentication applet 46 may instead be provided as a single applet within the secure element 4. As yet another alternative, a plurality of applets may be included within the secure element 4 providing the functionality of embodiments of the present invention according to any desired bundling or collection of the respective processing instructions.

Payment Transaction Process

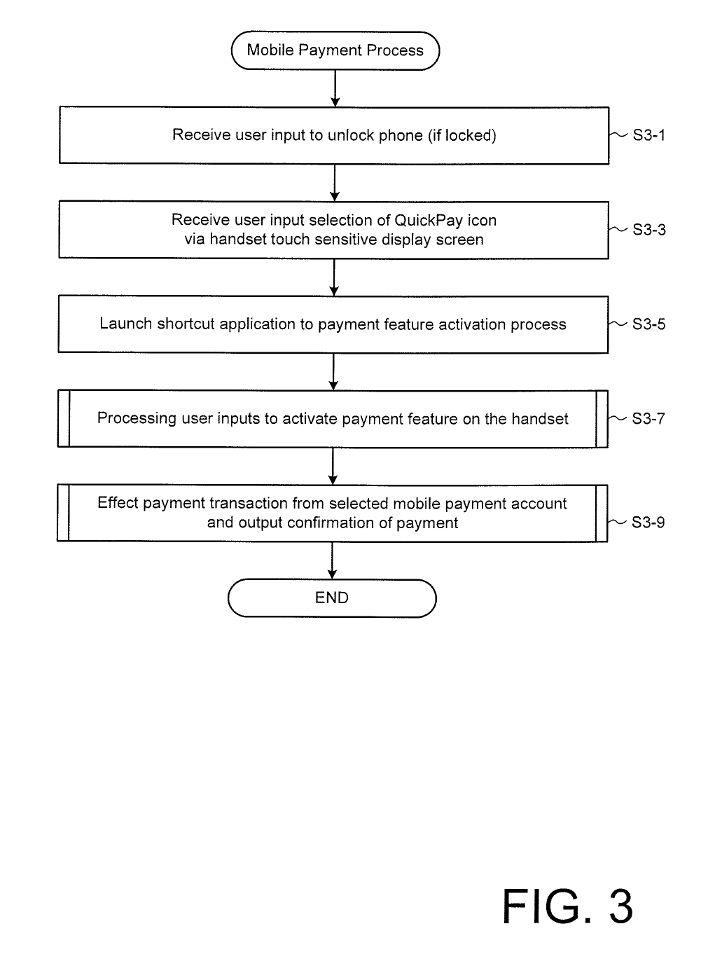

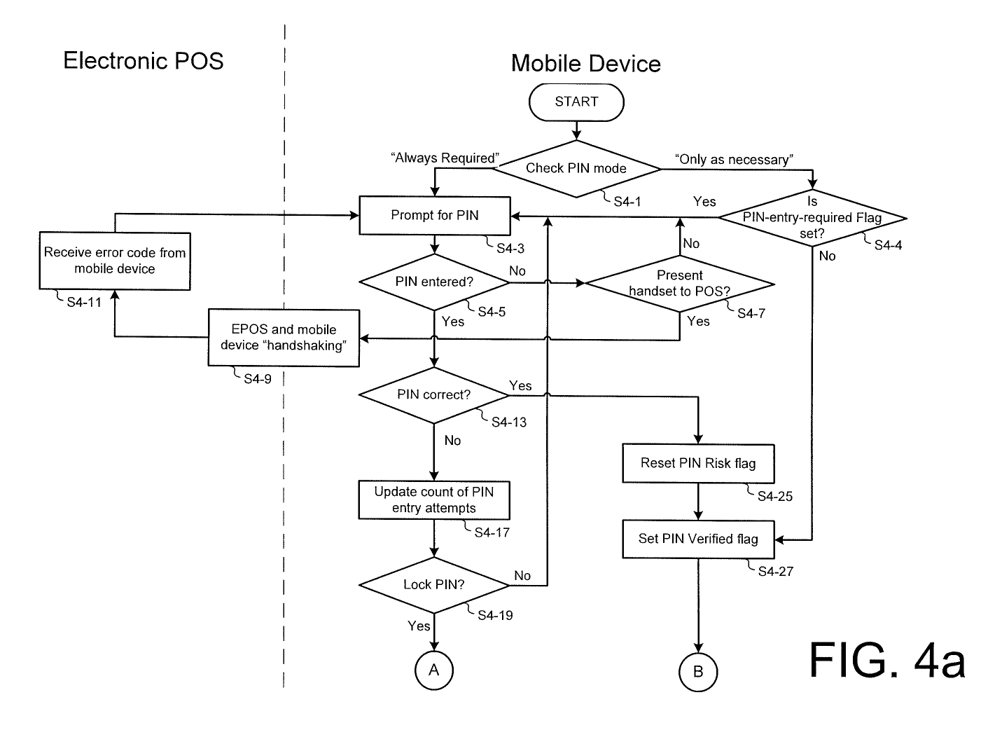

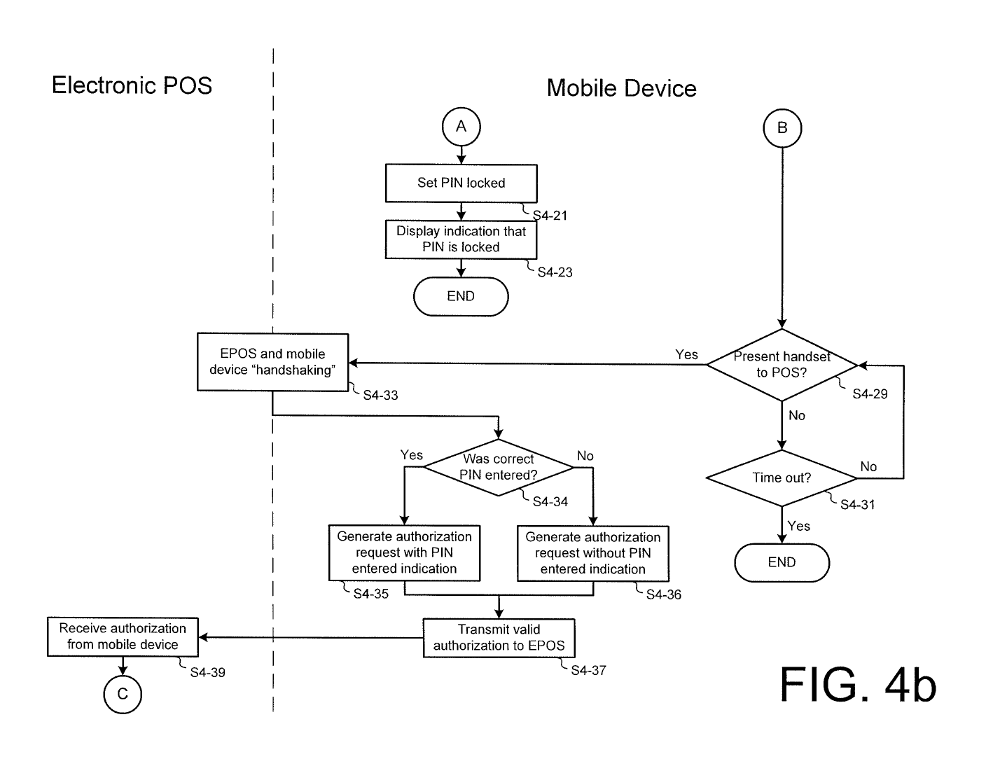

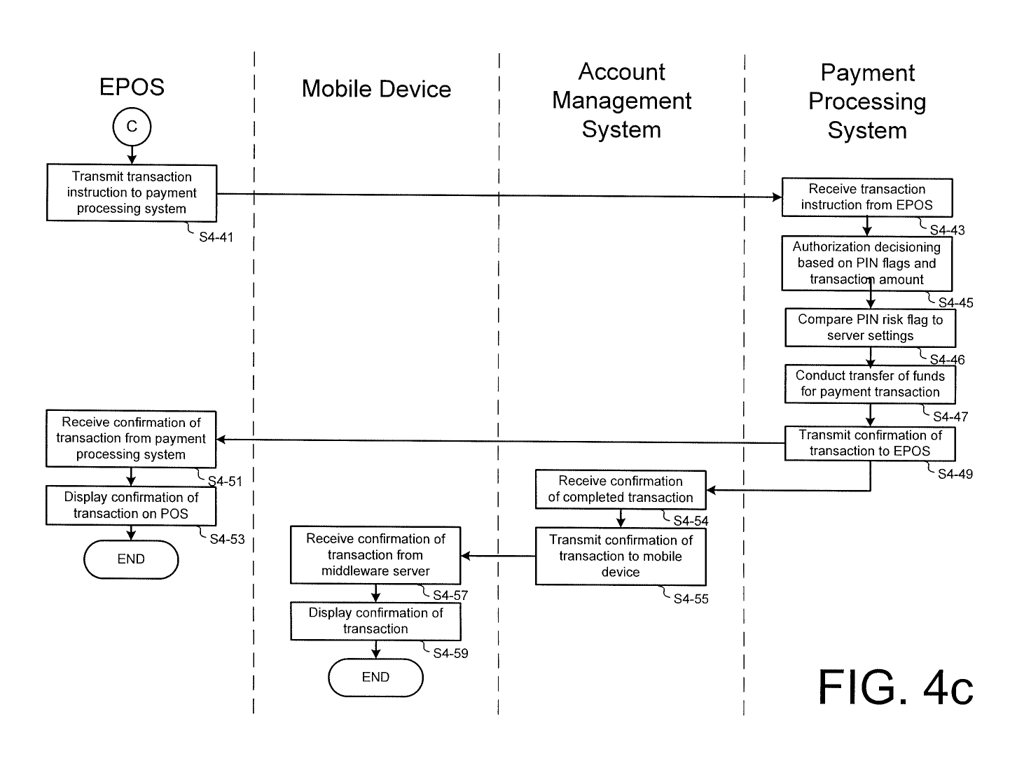

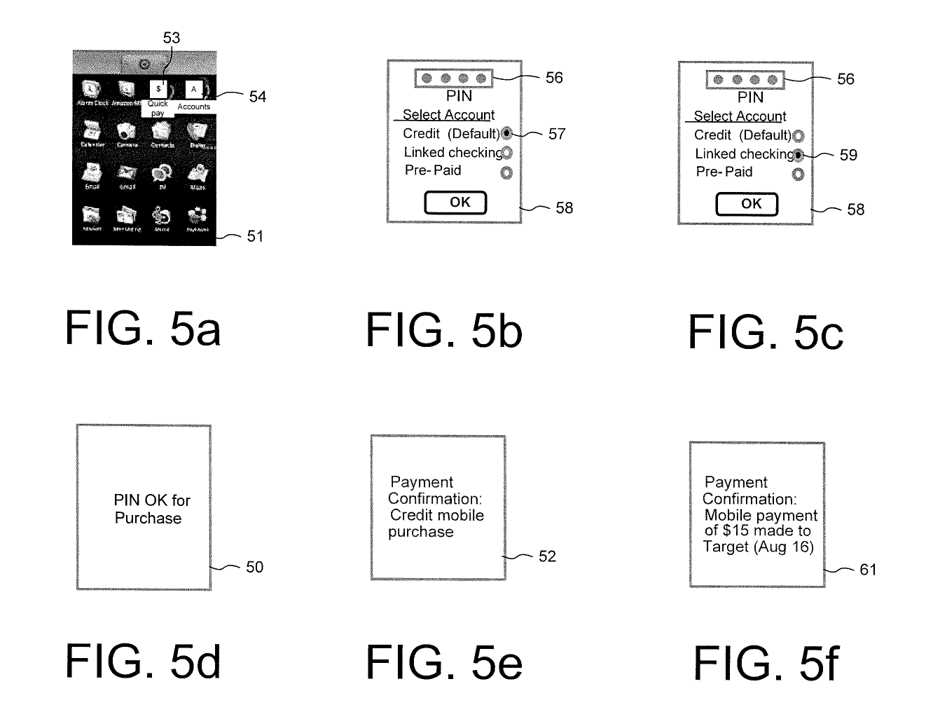

A brief description has been given above of the components forming part of the mobile payment system 1 of this embodiment. A more detailed description of the operation of these components in this embodiment will now be given with reference to the flow diagrams of FIGS. 3 and 4, for an example computer-implemented mobile payment transaction process using the mobile device 3 configured with one or more activated mobile payment accounts. Reference is also made to FIG. 5, which comprises FIGS. 5a to 5f, schematically illustrating exemplary display screens that may be presented to the user on the mobile device 3 in a payment transaction process.

As shown in FIG. 3, the process begins at step S3-1 where the mobile device 3 receives a user input to unlock the handset, if the handset is in a locked state. At step S3-3, the mobile device 3 receives a user input selection of an application icon 53 for the wallet application payment shortcut module 19, instead of the application icon 54 for the fully featured wallet application module 8. The user selection may be input for example via the mobile handset touch sensitive display screen 23 of the user interface 22. As those skilled in the art will appreciate, FIG. 5a illustrates an exemplary display 51 of user selectable icons for the various applications stored on the mobile handset and many other known arrangements will be apparent depending for example on the operating system and hardware of the mobile handset. In response to receiving the user input selection, the mobile device 3 launches the shortcut application and executes the processing instructions. In an embodiment, the processing instructions define a link to the processing instructions of the transaction authorization sub-module. In this way, at step S3-7, the user is directly presented with a wallet screen 55 for facilitating activation of the payment feature from the electronic wallet on the mobile handset, without having to navigate through menus and options of the main wallet application module 8 in order to find the activation wallet screen. Once the payment feature of a selected mobile payment account has been activated on the mobile device 3, the mobile device 3 can be used to conduct a payment transaction with the merchant electronic POS terminal 5 via the contactless communication link 9. In response to the user waving the mobile device 3 past a contactless communication interface of the POS terminal 5, the mobile device 3 effects a payment transaction from the selected mobile payment account and outputs confirmation of the payment transaction once completed at step S3-9.

FIG. 4, which comprises FIGS. 4a to 4c, illustrates the main processing steps performed by the main components of the mobile payment system 1 in the above steps S3-7 and S3-9 illustrated in FIG. 3. As shown in FIG. 4, processing user inputs to activate the payment feature on the mobile handset may start at step S4-1 with the wallet application module 8 calling the authentication applet instance 46 to check a PIN entry mode as set by the user. In this embodiment, the customer is able to make “tap and go” purchases for low dollar transactions. However, customers may elect to have a PIN set for all transactions. Therefore, a PIN mode is required for detecting this preference. The user selected configuration for the use of PIN, for example via the wallet application module 8, supports two PIN modes:

an “Always Required” mode, which results in no valid authorization request being transmitted from the mobile device 3 if a PIN is not entered. In this mode, the user will be required to successfully verify their PIN in order to process a valid transaction, regardless of whether the transaction value is high or low.

an “Only As Necessary” mode, which results in an authorization request that has indication of successful user PIN entry being generated and transmitted by the mobile device 3, and authorization decisioning may then be performed for example at the middleware server 16 based on other factors such as a transaction risk level (i.e. taking into consideration if the value of the payment transaction is above a threshold value, such as $50).

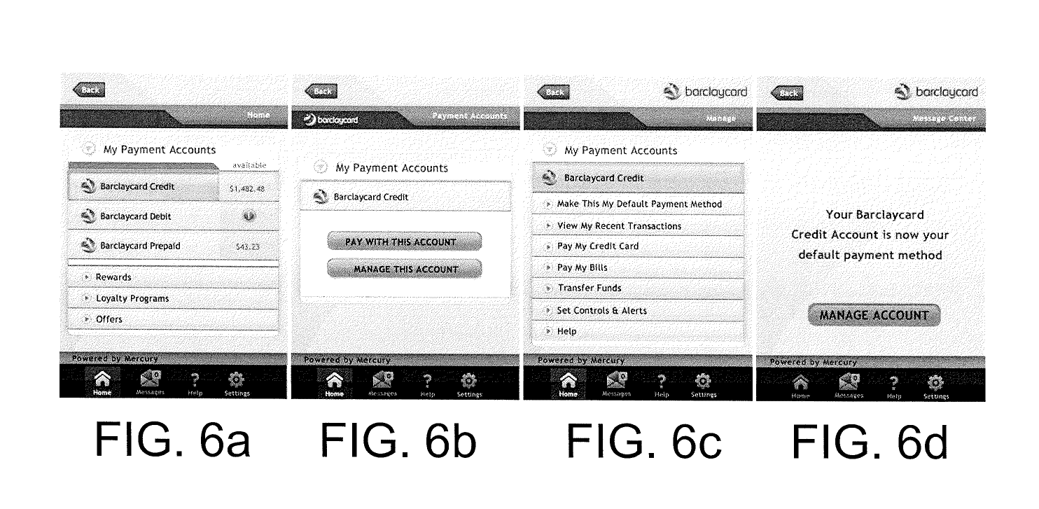

If the mobile device 3 determines that the PIN mode is set to “Always Required” at step S4-1, then at step S4-3, the mobile device 3 prompts the user for entry of a PIN. As schematically illustrated in FIG. 5b, the mobile device may display a wallet screen 55 which includes a prompt and a password field 56 for the user to enter a PIN and may also include a prompt for the user to change a selected one of the mobile payment accounts stored in the mobile handset as described above. The mobile payment wallet application module 8 may provide separate wallet screens 24 for facilitating user setting of a particular mobile payment account that is to be displayed as a selected payment account by default, as indicated by a selected account indication 57 for the default account. FIG. 5c shows an exemplary wallet screen 58 displaying a different selected account indication 59 after the user has selected a different mobile payment account 59 for conducting the subsequent payment transaction. User configuration of the default selected mobile payment account may be facilitated by wallet screens 24 accessible from the main menu wallet screen 26 for example, for accessing and changing mobile payment account details. FIGS. 6a to 6d show an exemplary sequence of wallet screens for accessing details for credit account linked with the mobile payment account, and for setting the credit account as the default payment method so that the credit account is displayed as the selected payment account by default.

At step S4-5, the mobile device 3 checks if user input of an entered PIN has been received, for example via the wallet screen 55. As those skilled in the art will appreciate, the entered PIN in the password field 56 may be masked on the displayed screen with hidden characters as the user inputs each character or number. Additionally, the user's sensitive mobile payment account details, such as card numbers, expiration dates and CVV codes, are encoded in the wallet application module 8 and never displayed on-screen, thereby further reducing the risk of fraud. If the mobile device 3 determines at step S4-5 that no PIN has been entered, then at step S4-7, the mobile device 3 checks if the handset has been waved past the contactless communication link interface of a POS terminal 5 and if not, processing returns to step S4-3 for the user to enter a PIN. As those skilled in the art will appreciate, when the mobile device 3 and POS terminal 5 are within range, one of the contactless communication link interfaces will initiate communication, referred to herein as “device handshaking”, to establish the contactless communication link, illustrated as step S4-9. It is commonly known that such contactless communication link interfaces generally communicate under the guidelines of ISO 14443, whereby the reader at the POS terminal 5 emits a signal that is received and interpreted by the contactless link interface 37 in the mobile device 3.

In this case, the user has not entered a PIN although the mobile device 3 is expecting a PIN and has proceeded to present the mobile device 3 to the POS terminal 5 at step S4-7. This may be because the user has simply forgotten to input a PIN and therefore at step S4-11, the POS terminal may receive an error code, which the POS terminal 5 may output so that for example a store clerk may see the displayed error and communicate to the customer. In an embodiment, the mobile device 3 may be arranged to display a message to the user indicating the need to enter a PIN in order to activate the payment feature. Alternatively, the mobile device 3 may be configured to not perform any interaction between the handset and the POS terminal 5 without a user entered PIN, and consequently at step S4-11, the POS terminal 5 may not react to the presence of the mobile device 3 because no appropriate data or request has been transmitted. Processing then returns to step S4-3 where the user is again prompted to enter a PIN.

On the other hand, if the mobile device 3 determines at step S4-5 that a PIN has been entered, then at step S4-13, the mobile device 3 verifies if the user input PIN is valid by comparing the input PIN with the user's pre-defined PIN stored in the wallet application secure data 6. If the mobile device 3 determines at step S4-13 that the user input PIN is not correct, then at step S4-17, the wallet application module 8 updates a count of the number of incorrect PIN entry attempts. As those skilled in the art will appreciate, the wallet application module 8 may be configured to check, at step S4-19, if a PIN is successively entered incorrectly a defined number of times and if so, to lock the PIN at step S4-21 and to display an indication that the PIN is locked at step S4-23. Locking of the PIN effectively prohibits the payment feature for the mobile payment account until the user has unlocked the PIN for example via a PIN reset process as will be apparent to those skilled in the art. On the other hand, if the PIN has not been successively entered incorrectly a defined number of times, then processing returns to step S4-3 where the user may be prompted to re-enter a correct PIN.

When the mobile device determines at step S4-13 that a correct PIN has been entered, then at step S4-25 the authentication applet 46 resets the PIN risk flag 103. At step S4-27, the authentication applet 46 sets the PIN-verified flag 109 that will be included in the next transaction authorization request. In an embodiment, the mobile device 3 may also be arranged to display a wallet screen 50 for example as schematically illustrated in FIG. 5d, to confirm that a verified PIN was entered and to indicate to the user that the selected mobile payment account is now enabled to conduct a payment transaction. At step S4-29, the mobile device 3 then checks if the contactless link interface 37 has been placed within range of a contactless communication link interface of a POS terminal 5. In an embodiment, the mobile device 3 may be configured to only allow a mobile payment transaction to be conducted using the selected mobile payment account within a predefined time window for example from the time when the correct PIN has been entered by the user. Therefore, at step S4-31, the mobile device 3 may check if a predefined time has elapsed since the correct PIN has been entered by the user, and to terminate the process if the handset is not presented to a POS terminal 5 in time. As those skilled in the art will appreciate, such a time out may reset the PIN entered and PIN verified flags. As discussed above, at step S4-33, when the mobile device 3 and POS terminal 5 are within range, the respective contactless communication link interfaces will initiate communication, typically in the form of device handshaking to establish the contactless communication link. In response, the wallet application module 8 checks, at step S4-34, if a correct PIN was entered by the user in step S4-13 above as necessary. The wallet application module 8 may for example check if the PIN entry flag 101 is set. If a correct PIN was entered by the user, then at step S4-35, the mobile device 3 generates an authorization request including a data value indicating that the correct PIN was entered. Otherwise, at step S4-36, the mobile device 3 generates an authorization request where the data value indicates that the no correct PIN was entered. As is commonly known, this indication may be provided as a unique transaction identifier of a verified PIN according to the specific contactless chip and/or card technology in use (for example the known dCVV or CVC3 identifiers). At step S4-37, the mobile device 3 transmits the valid authorization message to the electronic POS terminal 5 to authorize that the payment transaction be effected from the associated payment account issuer 10 to the merchant bank 12. The user entered PIN is therefore never transmitted by the mobile device 3 thereby further reducing risk of fraud.

The above procedure described the processing steps for the “Always Required” PIN mode. If at step S4-1, the mobile device 3 determines that the PIN mode is set to the “Only as necessary” mode, then step S4-4, the mobile device 3 checks if the PIN Risk flag 103 is set, thus requiring input of a passcode before a payment transaction can be authorized. If the PIN Risk flag 103 is set, then processing proceeds to step S4-3 as discussed above. However, if the PIN Risk flag 103 is not set, then processing proceeds directly to step S4-27 where the PIN verified flag 109 is set and the payment feature is activated without requiring user input of a PIN or passcode.

Thereafter, the POS terminal 5 may instruct a payment transaction from the user selected mobile payment account to the merchant bank in the normal manner, as will be briefly discussed with reference to FIG. 4. At step S4-39, the POS terminal 5 receives the authorization request from the mobile device 3 and at step S4-41 transmits a transaction instruction, via the payment association network 17, to the payment processing system 10a of the payment account issuer 10 associated with the user selected mobile payment account. At step S4-43, the payment processing system 10a receives the transaction instruction from the POS terminal 5 and in response, performs authorization decisioning for the instructed transaction at step S4-45. Authorization decisioning may be based on any number of factors, primarily checking that the available balance of the associated user payment account is sufficient to cover the payment transaction, and then for example checking if the PIN verified flag is set based on a transaction risk level (for example if the value of the transaction is above a predefined threshold value), and/or checking if the PIN was previously entered incorrectly, etc. In an embodiment, the payment processing system 10a may also consider whether the PIN risk flag is set on the mobile device 3 by comparing the PIN risk flag value to server settings at step S4-46. When the payment processing system 10a determines that the payment transaction is authorized, the transfer of funds from the account associated with the selected mobile payment account is effected at step S4-47, and confirmation of the transaction is transmitted to the POS terminal 5 at step S4-49. At step S4-51, the POS terminal 5 receives confirmation of the completed transaction from the middleware server 7 and at step S4-53, the POS terminal 5 outputs the confirmation to the merchant.

At step S4-54, the middleware server 16 of the account management system 7 may receive confirmation of the completed transaction from the payment processing system 10. In response, at step S4-55, the account management system 7 may optionally transmit confirmation of the completed transaction to the mobile device 3 via the cellular telephone network 11, for example. At step S4-57, the mobile device 3 receives the payment transaction confirmation from the account management system 7 and outputs, at step S4-59, confirmation of the payment transaction via a wallet screen 52, for example as schematically illustrated in FIG. 5e. The mobile device 3 may also be configured to output an audible confirmation of the payment.

In an embodiment, the user selected mobile payment account may be linked to a checking account at a payment account issuer 10. The authorized account details transmitted to the POS terminal 5 via the contactless communication link 9 identifies the payment account as a checking account. Typically, the POS terminal 5 will then request additional input from the user before the payment transaction can be completed by the POS terminal 5. For example, the additional input may be in the form of a prompt to select a specific payment type such as credit or debit, and the user may be required to input a signature for example via a touch sensitive input screen of the POS terminal 5.

In an embodiment, the middleware server 16 may be additionally configured to receive details of the payment transaction, for example from the payment account issuer 10 after the payment has been transferred or from the merchant POS terminal 5 or merchant bank 12 directly. In response, the middleware server 16 may be further arranged to communicate additional confirmation of the payment to the mobile device 3, including for example details of the amount of funds that was transferred, the name of the target recipient, and the date of the payment transaction. The additional payment confirmation may be displayed by the mobile device 3 as a further payment confirmation wallet screen 61, for example as schematically illustrated in FIG. 5f.

### Remote PIN Management

In an embodiment of the present invention, the payment processing (authorization and fraud monitoring) system 10a may additionally be configured to offer additional tools to remotely set the PIN risk flag 103 stored securely on the mobile device 3 to force a challenge the next time the mobile device 3 is used to make a transaction attempt as described above. With the PIN risk flag 103 set on the mobile device 3, the customer will be always be asked to enter their passcode/PIN before another transaction, regardless of transaction amount, can be made on the mobile device in the manner described above. Once the passcode is entered on the mobile device 3, the risk flag 103 is unset on the secure element 4 to allow a transaction to the point of sale. Without the PIN risk flag 103, a thief may steal a phone and would be able to use that phone indefinitely for multiple low dollar transactions without ever being prompted for a PIN. With the facility to remotely set the PIN risk flag 103, the payment processing system 10a could be additionally configured with a set threshold of usage or to react to unusual purchase patterns or based upon a number of low dollar transactions since the PIN was entered last. Such an implementation can beneficially be used to efficiently monitor low dollar transactions. As is commonly known, such low dollar transactions are typically the payment issuer's liability and are not generally able to be charged back to the retailer. As discussed above, the information that a verified passcode or PIN entry has been made would be sent with the next transaction to inform the merchant and payment issuer systems that the customer has verified themselves. Even small dollar transactions could be blocked at the issuing bank until the customer verified themselves.

In order to set the risk flag remotely, the payment processing system 10a may be configured to detect unusual usage based upon a variety of predefined risk factors. The risk factors detect unusual behavior from a customer and can include a combination of attributes such as unusual merchant locations for the customer, time of day differences from normal usage patterns, a higher velocity of transaction attempts, or other proprietary models. Current issuing bank processes can shut off the payment capability of a payment account until the user verifies possession of the payment account to the bank, but this new process allows for a gentler interaction between the customer and the bank. The present embodiment advantageously allows for the customer to verify themselves in the act of payment when the customer wishes to make their next payment. This further reduces the number of bank resources required to contact customers and manage the fraud flags on accounts.

Current plastic card based contactless technologies can only be updated when in contact with a chip card reader. Some payment association specifications allow for account updates to contactless cards via these chip card readers, but these are rarely used since these payment accounts are typically waved over a reader versus inserted into a dedicated chip card reader. Adding the payment account to a mobile device allows for additional data fields to be sent over the air to the mobile device to effect payments.

A summary of the remotely set risk flag process in mobile device enabled payment transactions will now be provided.

In this embodiment, the process would detect the anomaly using current payment authorization processes and then communicate the new risk flag value to the mobile device 3, for example over the air via a Trusted Service Manager (TSM) and cellular communication networks. The updated risk flag value would be stored into the secure memory space 4 of the mobile device 3 where the PIN risk flag 103 resides, in control of the payment account issuer 10. This PIN risk flag 103 updating process may start for example with an issuing bank fraud detection system deciding the payment account is not to be trusted without further customer verification. The fraud detection system may elect to prevent any new transactions until the PIN risk flag 103 has been cleared. The bank fraud detection system would then send a message to the bank's payment processing system 10a with the specific customer account information and risk flag setting. In many cases, the issuing bank will have a TSM of their own that will broker communication to a mobile network operator's TSM which will talk to the phone. The bank's payment processing system 10a would communicate with the issuing bank TSM to logically and physically prepare the new risk flag data commands for the targeted mobile device 3. The issuing bank TSM communicates with the mobile network operator TSM to deliver the new risk flag 103 to the mobile device 3. Once received by the mobile phone 3, the new risk flag setting will be placed into the secure memory storage 4 for use in the next transaction as described above with reference to FIG. 4.

As described above, on the mobile device 3, the transaction process can vary based upon user provided settings to either require a passcode prior to any transaction attempt, or provide a passcode only for high value transactions—for example any transactions above a threshold value between $25 and $50 based upon the issuing bank and payment association rules. Payments from mobile devices 3 as described above generally follow a process as follows. The mobile device is held near a point of sale (POS) reader. The reader emits a signal received and interpreted by the contactless link interface in the mobile device. The contactless reader interface is a near field communication (NFC) process generally communicating under the guidelines of ISO 14443 and further refined by payment association specifications for specifying the message values between the contactless reader interface of the POS terminal 5 and mobile device 3.

The contactless reader interface identifies the point of sale communication is a payment request. As configured in the mobile device 3, the PPSE application 41 may be called to provide a payment account instance within the secure element 4 processor subsystem. The PPSE 41 determines the payment account currently selected for use on the mobile handset and hands control to a payment association specific instantiation 40 of a payment application that ultimately provides the account information.

The payment application 40 within the secure element 4 of the mobile device 3 will determine if the passcode was required, entered and then pass that information along with the payment account information for use in the transaction. The payment application 40 can also access other data values stored within the secure element 4 such as the risk flag 103. The payment application 40 may also use local values to determine if the user preference for the passcode needing to be verified or other counters for allowing only so many transactions before a passcode to be entered. The remote setting of the risk flag 103 is one opportunity for issuing banks to allow multiple small dollar transactions within normal customer transaction operations and ask only for the passcode in case of unusual customer activity.

If the risk flag 103 is set to a value requiring user input, the payment application 40 may return an error value to the contactless reader interface as well as messaging to the mobile device to alerting the user that a passcode is required before a transaction can be made. Other reasons for passcode required entry are if the user has set their preference to always require passcode entry for any transaction. Otherwise, the payment application will allow the transaction.

If the payment application 40 allows the transaction to proceed, the specific payment account data is passed back to the POS terminal 5. The POS terminal 5 interprets the message and assembles the payment account data for a transaction request to the association payment network. The message is routed through the payment network to the payment account issuer 10.

The transaction request is received at the payment account issuer 10 and processed for approval based upon funds availability as well as fraud decision strategies. The setting of the value of the risk flag is kept at the issuer systems and the current value of the passcode verification is sent with each mobile transaction request to the payment account issuer 10 over the payment network authorization message. Among all other rules determining transaction success at the issuer's payment authorization system, the transaction will be denied if the passcode is not verified and the risk flag is set to a value on the mobile device. Additional risk and fraud strategies may be employed by the payment account issuer 10 to determine if this transaction will be allowed as per normal business processes.

If the risk flag 103 is set at the time of transaction attempt, and the passcode has been entered—passed in via the transaction request, this action will clear then the payment processing system 10a flags that the fraud check has been passed. This action will restart any low dollar risk checks for unusual usage and the risk flag 103 may be set again at some future point of time.

The remote setting of a risk flag 103 therefore allows customers to make a number of low dollar transactions without ever having to enter a passcode if the bank system sees the activity as normal use. The customer will not be forced to enter a passcode every set number of low dollar transactions if the bank feels the risk is low.

An addition to this process could be a remote setting of the number of low dollar transactions to be used before the next passcode verification is required. If a local counter mechanism for passcode verification is employed on the mobile handset 3, the counter could be set remotely by the payment account issuer 10 via the same TSM process described above. This could allow a flexible counter to be increased over time as usage patterns are determined by the issuing bank and customer habits are formed. Upon successful entry of the passcode, the counter is reset to the value.

### Advantages

A number of advantages will be understood from the above description of the embodiments of the present invention.

In particular, the remote setting of a risk flag can prevent monetary loss by the issuing bank for low dollar transactions made by a perpetrator.

The solution allows the customer to easily self correct any possession activity verification without requiring an outbound contact from the issuing bank. The customer simply enters their passcode prior to making their next transaction.

The issuing bank can set the risk flag ahead of any transaction attempt by the customer at a merchant. The merchant checkout does not have to communicate a declined transaction attempt to the customer. If the merchant were an unattended vending machine, this error could cause customer confusion and frustration. The customer is able to correct their risk setting locally as part of the transaction flow.

The transaction information process flow with merchant point of sale systems is unchanged requiring no additional work by a merchant.

The embodiments allow the bank to decide when a customer requires authentication of the payment account based upon flexible risk criteria.

The embodiments also allow for remote management of local passcode verification counters to allow the bank to automatically ask for passcode verification after a configurable number of low dollar transactions.

### Alternative Embodiments

It will be understood that embodiments of the present invention are described herein by way of example only, and that various changes and modifications may be made without departing from the scope of the invention.

For example, in the embodiments described above, the mobile payment account is provisioned on a mobile handset which communicates with the account activation system via a cellular telephone network. As those skilled in the art will appreciate, instead of a mobile handset, other portable electronic devices configured for contactless payment with a merchant electronic POS and having suitable input and display means, may be adapted to carry out the functionality of real time provisioning and/or activation as described in the above embodiment. Additionally, those skilled in the art will appreciate that the portable electronic device may be configured to communicate with the account activation system via any other form of communication channel, such as a wired or wireless network connection, a Bluetooth connection, or the like. Alternatively, the mobile payment account data may be provisioned on the portable electronic device by means of data transfer for example via any suitable data communication path or by way of a computer readable medium.

In the embodiments described above, the mobile device is provisioned with a mobile payment account through secure transfer of data representing the mobile payment account, which data including data defining an amount of pre-paid funds transferred from the user's payment account issuer and/or data identifying a user's account at a payment account issuer from which funds can be transferred to a merchant bank to complete a transaction. As those skilled in the art will appreciate, the mobile device may instead or additionally be securely provisioned with data representing one or more other types of accounts, such as an insurance account, a loyalty and rewards scheme membership or the like, and the account activation system may be configured to conduct a secure data transfer to the mobile device of data representing such an account, for example including the account or membership number or any other type of secure reference number.

In the embodiments described above, the wallet application secure data stores a plurality of flags that are accessed and maintained by the payment and authentication applets. As those skilled in the art will appreciate, the flags are data values indicative of one of a plurality of predefined states of an associated variable. In the embodiments described above, separate flags are provided for the plurality of variables, each flag having a true or false state. Many alternative forms of representing the flags and variable states will be apparent to the skilled person.

In the embodiment described above, the mobile device stores a plurality of application modules (also referred to as computer programs or software) in memory, which when executed, enable the mobile device to implement embodiments of the present invention as discussed herein. As those skilled in the art will appreciate, the software may be stored in a computer program product and loaded into the mobile device using any known instrument, such as removable storage disk or drive, hard disk drive, or communication interface, to provide some examples.

In the embodiments described above, the account management system is described as a separate entity to the payment account issuer and the associated payment processing system. As those skilled in the art will appreciate, the account management system may be provided as an integral part or sub-system of the payment account issuer and/or payment processing system.

Alternative embodiments may be envisaged, which nevertheless fall within the scope of the following claims.

1. A method of facilitating secured payment from an electronic wallet on a portable device, comprising:
storing, on the portable device, an electronic wallet comprising data for authorizing a payment transaction, wherein said data includes a passcode for enabling access to the electronic wallet and a flag indicating whether input of the passcode is required to access the electronic wallet;
receiving, from a remote apparatus, a command to set the flag to indicate that input of the passcode is required to access the electronic wallet; and
responsive to a request to conduct a payment transaction from the electronic wallet, prompting for input of a passcode if the flag indicates that input of the passcode is required, verifying the input passcode, and providing payment information to authorize the payment transaction.

2. The method of claim 1, wherein the remote apparatus is a server associated with a payment account issuer.

3. The method of claim 1, wherein the flag is set based on a threshold of usage of the electronic wallet.

4. The method of claim 1, wherein the flag is set based on an unusual purchase pattern from the electronic wallet.

5. The method of claim 1, wherein the flag is set when an incorrect passcode is entered.

6. The method of claim 1, wherein the flag is set after a predefined number of payment transactions have been authorized without requiring input of the passcode.

7. The method of claim 1, wherein the flag is reset upon verification of an input passcode.

8. The method of claim 1, wherein the flag is reset in response to a remote command.

9. The method of claim 1, wherein the electronic wallet data is stored in a secure element of the mobile device.

10. The method of claim 1, wherein the received command is encrypted.

11. A method of facilitating payment from an electronic wallet on a portable device, comprising:
storing, on the portable device, wallet application software for accessing the electronic wallet, including executable code for facilitating access to data defining one or more mobile payment accounts in the electronic wallet and executable code for facilitating activation of a secure payment from a mobile payment account;
storing, on the portable device, further payment application software associated with the executable code in the wallet application software for facilitating activation; and
receiving a user input selection of the second application software and in response, directly executing the associated executable code in the first application software to facilitate activation of a secure payment from the mobile payment account.

12. The method of claim 11, wherein payment is secured by validating a user input passcode before payment from the electronic wallet is activated.

13. The method of claim 12, wherein validating the user input passcode comprises comparing the input passcode with a stored passcode for the electronic wallet.

14. The method of claim 11, wherein the further payment application software comprises executable code defining a shortcut link to the executable code of the wallet application software for facilitating activation of a secure payment from a mobile payment account.

15. The method of claim 11, wherein the payment application software is further associated with executable code for conducting a payment transaction after activation.

16. The method of claim 15, wherein the electronic wallet stores a plurality of mobile payment accounts, and wherein the executable code for conducting a payment transaction after activation comprises prompting for a user selected one of the mobile payment accounts.

17. The method of claim 16, wherein the selected mobile payment account is predefined as a default selected mobile payment account.

18. The method of claim 17, wherein the plurality of mobile payment accounts enable the user to conduct a payment transaction with an associated debit account, credit account, linked checking or decoupled debit account and/or pre-paid account.

19. The method of claim 11, wherein the wallet application software further includes executable code for facilitating creation of a mobile payment account in the electronic wallet, the mobile payment account associated with a payment account issuer.

20. A graphical user interface for facilitating payment from an electronic wallet on a portable device, comprising a first icon associated with wallet application software for accessing the electronic wallet, including executable code for facilitating access to data defining one or more mobile payment accounts in the electronic wallet and for facilitating activation of a secure payment from a mobile payment account; a second icon associated with executable code for facilitating direct activation of a secure payment from a mobile payment account; and receiving user selection of the second icon and directly executing the application software for facilitating activation of a secure payment from a mobile payment account.

21. The graphical user interface of claim 20, wherein the second icon is associated with a shortcut link directly to the executable code of the wallet application software for facilitating activation of a secure payment from a mobile payment account.

22. The graphical user interface of claim 20, wherein the second icon is further associated with executable code for conducting a payment transaction after activation.

23. The graphical user interface of claim 20, wherein activation includes receiving and validating a user input passcode.

24. The graphical user interface of claim 22, wherein the electronic wallet stores a plurality of mobile payment accounts, and wherein the executable code for conducting a payment transaction after activation comprises prompting for a user selected one of the mobile payment accounts.

25. The graphical user interface of claim 24, wherein the selected mobile payment account is predefined as a default selected mobile payment account.

26. A portable device adapted to perform the method of facilitating payment from an electronic wallet on the portable device as set out in claim 1.

27. A portable device comprising the graphical user interface of claim 20.

28. A mobile payment system comprising the portable device of claim 26 operable to communicate with a merchant electronic point of sale terminal via a contactless communication link to conduct a payment transaction using the electronic wallet on the portable device.

29. A computer program comprising program code arranged to perform a method of facilitating payment from an electronic wallet on a portable device when executed by the portable device, comprising:
computer-implementable instructions for storing, on the portable device, an electronic wallet comprising data for completing a payment transaction, wherein said data includes a passcode for enabling access to the electronic wallet and a flag indicating whether input of the passcode is required to access the electronic wallet;
computer-implementable instructions for receiving a command from a device remote from the portable device to set the flag to indicate that input of the passcode is required to access the electronic wallet; and
computer-implementable instructions, responsive to a request to conduct a payment transaction from the electronic wallet, for prompting for input of a passcode if the flag indicates that input of the passcode is required, verifying the input passcode, and providing payment information to authorize the payment transaction.

30. A computer program comprising program code arranged to perform a method of facilitating payment from an electronic wallet on a portable device when executed by the portable device, comprising:
computer-implementable wallet application software for accessing the electronic wallet, including executable code for facilitating access to data defining one or more mobile payment accounts in the electronic wallet and executable code for facilitating activation of a secure payment from a mobile payment account;
computer-implementable payment application software including executable code associated with the executable code in the wallet application software for facilitating activation, wherein in response to a user input selection of the second application software, the linked executable code in the first application software is executed directly by the portable device to facilitate activation of a secure payment from the mobile payment account.

31. A computer program product comprising the computer program of claim 29.

32. A computer program product comprising the computer program of claim 30.

33. A portable device adapted to perform the method of facilitating payment from an electronic wallet on the portable device as set out in claim 11.

34. A mobile payment system comprising the portable device of claim 27 operable to communicate with a merchant electronic point of sale terminal via a contactless communication link to conduct a payment transaction using the electronic wallet on the portable device.
